(19) United States
(12) Patent Application Publication
(10) Pub. No.: US 2012/0238330 A1
(43) Pub. Date: Sep. 20, 2012

(54) APPARATUS THAT CONNECTS WIRELESSLY TO A CELL PHONE VIA BLUETOOTH TECHNOLOGY AND PROVIDES ADDITIONAL RINGING SOUND AND VISUAL ALERT UPON AN INCOMING CALL

(76) Inventor: WILLIE WU, FAIRVIEW, TX (US)

(21) Appl. No.: 13/112,011

(22) Filed: May 20, 2011

Related U.S. Application Data
(60) Provisional application No. 61/452,265, filed on Mar. 14, 2011.

(51) Int. Cl. H04M 1/00

(52) U.S. Cl. 455/569.1

(57) ABSTRACT

An auxiliary sound/light indicating device includes a housing, in which a control circuit composed of a microcontroller, an MP3 player, a light-emitting element, and a Bluetooth module is provided. The auxiliary sound/light indicating device is wirelessly connected to a mobile communication apparatus via Bluetooth connection. The microcontroller controls the emission of sound and light, enables ringing sound programming and caller ID display setting. Through the Bluetooth connection, the auxiliary sound/light indicating device can emit sound and/or light to inform a user of an incoming call on the mobile transmission apparatus and display the caller ID, allowing the user to decide whether to answer or reject the incoming call. And, when the mobile communication apparatus is out of an effective Bluetooth transmission range and the Bluetooth connection is interrupted, the auxiliary sound/light indicating device emits warning sound and/or light to remind the user of possible loss of the mobile communication apparatus.

### REFERENCE TO RELATED APPLICATIONS

This Application is based on Provisional Patent Application Ser. No. 61/452,265, filed 14 Mar. 2011, currently pending.

### FIELD OF THE INVENTION

The present invention relates to an auxiliary sound/light indicating device, and more particularly to an auxiliary sound/light indicating device that is wirelessly connected to a mobile communication apparatus via Bluetooth connection for emitting sound and/or light and/or displaying a caller identification (ID) whenever there is an incoming call on the mobile communication apparatus, allowing a user to decide whether to answer or reject the incoming call. And, when a distance between the mobile communication apparatus and the auxiliary sound/light indicating device is larger than an effective Bluetooth transmission range and the Bluetooth connection is interrupted, the auxiliary sound/light indicating device will emit warning sound and/or light to remind the user of possible loss of the mobile communication apparatus.

### BACKGROUND OF THE INVENTION

Due to its convenience for use, the mobile communication apparatus has become a prerequisite tool in many people's daily life and work. The currently available mobile communication apparatus is compact in design to have small size and volume, and a user would usually place it in a pocket or a handbag. With the mobile communication apparatus placed in the pocket or handbag, the user might not be able to timely notice the indicator light or ringing sound or vibration of the mobile communication apparatus that informs the user of an incoming call. As a result, the user might miss some important calls. Further, the compact mobile communication apparatus is easily lost due to its small size and volume.

It is therefore tried by the inventor to develop an auxiliary sound/light indicating device for wirelessly connecting to a mobile communication apparatus via Bluetooth connection, so that the auxiliary sound/light indicating device can emit sound and/or light and/or display a caller ID whenever there is an incoming call on the mobile communication apparatus, allowing the user to decide whether to answer or reject the incoming call. And, when a distance between the mobile communication apparatus and the auxiliary sound/light indicating device is larger than an effective Bluetooth transmission range and the Bluetooth connection is interrupted, the auxiliary sound/light indicating device will emit warning sound and/or light to remind the user of possible loss of the mobile communication apparatus.

### SUMMARY OF THE INVENTION

A primary object of the present invention is to provide an auxiliary sound/light indicating device wirelessly connected to a mobile communication apparatus via Bluetooth connection, so that the auxiliary sound/light indicating device can emit reminding sound and/or light and/or display a caller ID whenever there is an incoming call on the mobile communication apparatus.

Another object of the present invention is to provide an auxiliary sound/light indicating device wirelessly connected to a mobile communication apparatus via Bluetooth connection, so that the auxiliary sound/light indicating device can emit warning sound and/or light when the mobile communication apparatus is located out of an effective Bluetooth transmission range from a user and the Bluetooth connection is interrupted.

To achieve the above and other objects, the auxiliary sound/light indicating device according to the present invention includes a housing, in which a control circuit composed of a microcontroller, an MP3 player, a light-emitting element, and a Bluetooth module is provided. The auxiliary sound/light indicating device is wirelessly connected to a mobile communication apparatus via Bluetooth connection. The microcontroller controls the emission of sound and light, enables ringing sound programming and caller ID display setting. Through the Bluetooth connection, the auxiliary sound/light indicating device can emit sound and/or light to inform a user of an incoming call on the mobile transmission apparatus and/or display the caller ID, allowing the user to decide whether to answer or reject the incoming call. And, when the mobile communication apparatus is located out of an effective Bluetooth transmission range from the user and the Bluetooth connection is interrupted, the auxiliary sound/light indicating device can emit warning sound and/or light to remind the user of possible loss of the mobile communication apparatus.

In a preferred embodiment of the auxiliary sound/light indicating device according to the present invention, the control circuit includes a USB (universal serial bus) terminal, allowing connection of the auxiliary sound/light indicating device to a computer via the USB terminal for charging a battery of the device and setting up different control programs for the device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing an auxiliary sound/light indicating device for mobile communication apparatus according to an embodiment of the present invention;

FIG. 2 is a block diagram of a control circuit for the auxiliary sound/light indicating device of the present invention;

FIG. 3 shows an example of using the auxiliary sound/light indicating device of the present invention; and

FIG. 4 shows another example of using the auxiliary sound/light indicating device of the present invention.

### DETAILED DESCRIPTION OF THE PREFERRED EMBODIMENTS

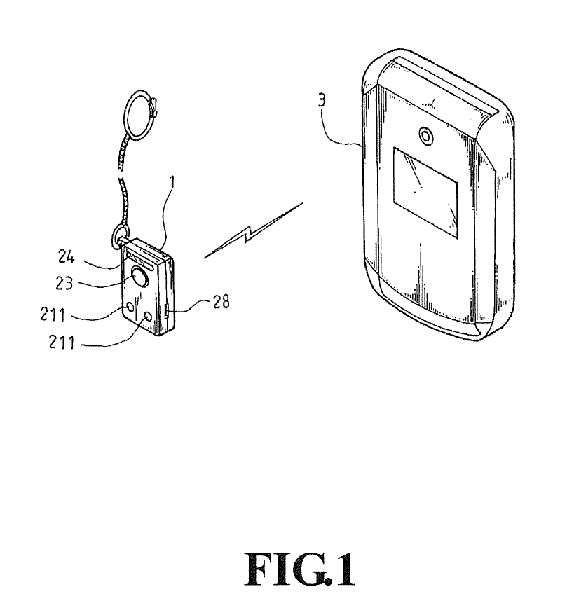

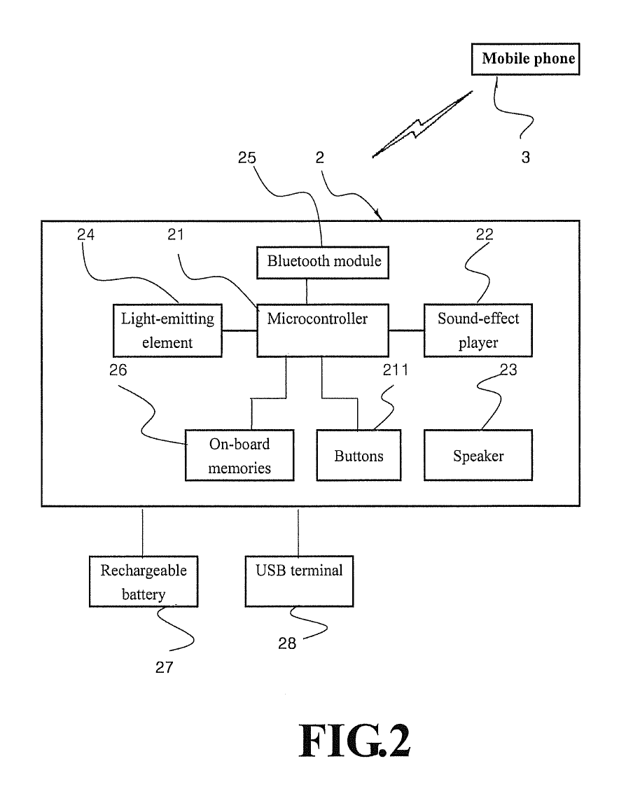

Please refer to FIG. 1 that is a perspective view showing an auxiliary sound/light indicating device 100 according to an embodiment of the present invention for wirelessly connected to a mobile communication apparatus 3; and to FIG. 2 that is a block diagram of a control circuit 2 for the auxiliary sound/light indicating device 100. As shown, the auxiliary sound/light indicating device 100 includes a housing 1, in which a control circuit 2 is provided. The control circuit 2 includes a microcontroller 21, to which a sound-effect player 22, a speaker 23, and a light-emitting element 24 is connected; a Bluetooth module 25; and on-board memories 26. In the illustrated embodiment, the speaker 23 is a mini speaker or a buzzer, and the light-emitting element 24 is a light-emitting diode. The microcontroller 21 controls the emission of sound and light, enables ringing sound programming and caller identification (ID) display setting. The microcontroller 21 is also connected to a plurality of externally accessible buttons 211, via which a user can set up Bluetooth connection, sound and light emission control, and ringing sound programming, and preset phone numbers to be recognized. The phone numbers preset via the buttons 211 are sent to the microcontroller 21 and stored on the on-board memories 26. The microcontroller 21 can also extract the caller identification and phone number from the Bluetooth module 25. The whole control circuit 2 is powered by a rechargeable battery 27. Both the microcontroller 21 and the battery 27 are connected to a USB terminal 28 provided on the housing 1.

The auxiliary sound/light indicating device 100 is wirelessly connected to the mobile communication apparatus 3, which is a cell phone in the illustrated embodiment, through Bluetooth connection. For example, when the cell phone 3 is placed in a user's handbag, the user may hang the auxiliary sound/light indicating device 100 on the handbag or any other position on the user's body. Whenever there is an incoming call on the cell phone 3, the auxiliary sound/light indicating device 100 wirelessly connected to the cell phone 3 via Bluetooth connection can emit sound and/or light to remind the user of the incoming call. Through the caller ID display function provided by the auxiliary sound/light indicating device 100, the user can recognize the caller and decide to answer or reject the incoming call. The control circuit 2 can be connected to a computer via the USB terminal 28 to set up control programs or charge the rechargeable battery 27.

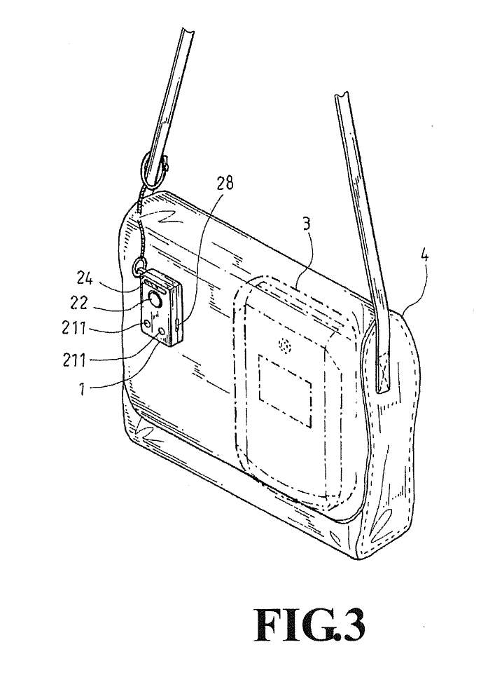

FIG. 3 shows a first example of using the auxiliary sound/light indicating device 100 of the present invention. Please refer to FIG. 3 along with FIG. 2. In this example, the cell phone 3 is placed in a user's handbag 4. As a result, the user can not see any light emitted from an indicator light on the cell phone 3, or hear the cell phone ringing, or feel the cell phone vibrating. However, the auxiliary sound/light indicating device 100 can be externally hung on the handbag 4 or connected to any other position on the user's body, such as connected to the user's waistband or belt. Whenever there is an incoming call on the cell phone 3, the Bluetooth connection between the cell phone 3 and the auxiliary sound/light indicating device 100 not only enables the sound-effect player 22, such as an MP3 player, and the speaker 23 of the auxiliary sound/light indicating device 100 to emit a particularly programmed ringing sound, but also enables the light-emitting element 24 to emit light, preventing the user from missing any important phone call. Since the microcontroller 21 provides the caller ID display function and is able to compare the caller's phone number with the preset phone numbers stored on the on-board memories 26, the user can recognize the caller and decide to answer or reject the incoming call by pushing one of the buttons 211.

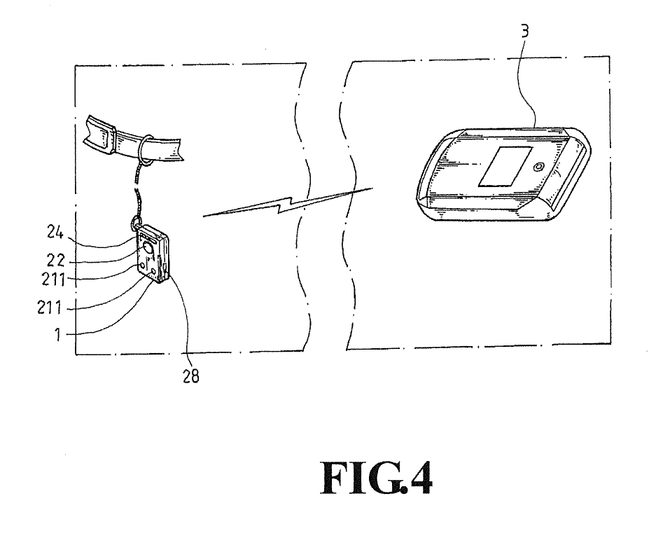

FIG. 4 shows a second example of using the auxiliary sound/light indicating device 100 of the present invention. Please refer to FIG. 4 along with FIG. 2. In addition to the functions of informing the user of an incoming call on the wirelessly connected mobile communication apparatus and displaying the caller ID, the auxiliary sound/light indicating device 100 of the present invention also provides cell phone loss prevention function and remote caller ID display function via the Bluetooth connection between the

Bluetooth module 25 and the cell phone 3. In the case the cell phone 3 and the auxiliary sound/light indicating device 100 are separated from each other by a distance long enough to cause interrupted Bluetooth connection between, the auxiliary sound/light indicating device 100 will emit warning sound and/or light via control of the microcontroller 21 to achieve the cell phone loss prevention function. Alternatively, there are chances the cell phone 3 and the auxiliary sound/light indicating device 100 are located at different places. For example, it is possible the cell phone 3 is positioned in one of many rooms, while the auxiliary sound/light indicating device 100 is carried by the user and located in another room. In the case a distance between the separated cell phone 3 and auxiliary sound/light indicating device 100 is still within an effective Bluetooth transmission range, the auxiliary sound/light indicating device 100 can still detect an incoming call on the cell phone 3 and emits sound and/or light to remind the user of the incoming call. And, in the case the distance between the separated cell phone 3 and auxiliary sound/light indicating device 100 is larger than an effective Bluetooth transmission range and the Bluetooth connection is interrupted, the auxiliary sound/light indicating device 100 would emit warning sound and/or light to remind the user of possible cell phone loss.

In conclusion, the auxiliary sound/light indicating device according to the present invention includes a control circuit composed of a microcontroller, a sound-effect player, a light-emitting element, and a Bluetooth module; and can be wirelessly connected to a mobile communication apparatus, such as a cell phone, via Bluetooth connection.

Through the Bluetooth connection between the cell phone and the auxiliary sound/light indicating device, the auxiliary sound/light indicating device can inform a user of an incoming call on the cell phone by emitting sound and/or light. And, in the case the Bluetooth connection between the cell phone and the auxiliary sound/light indicating device is interrupted, the auxiliary sound/light indicating device can emit warning sound and/or light to remind the user of possible cell phone loss. The auxiliary sound/light indicating device also provides the function of caller ID display, allowing the user to decide whether to answer or reject the incoming call. These features and advantages make the auxiliary sound/light indicating device for mobile communication apparatus according to the present invention novel, improved, and practical for use.

The present invention has been described with a preferred embodiment thereof and it is understood that many changes and modifications in the described embodiment can be carried out without departing from the scope and the spirit of the invention that is intended to be limited only by the appended claims.

1. An auxiliary alert device for a mobile communication apparatus, comprising:
a housing; and
a control circuit disposed in the housing, the control circuit comprising:
a microprocessor;
sound and light emitting components; and
a Bluetooth module, the Bluetooth module and the sound and light emitting components coupled to the microprocessor, the Bluetooth module enabling Bluetooth communication with the mobile communication apparatus, the sound and light emitting components emitting sound and/or light to alert a user of an incoming call on the mobile communication apparatus;
wherein the control circuit is user programmable to emit a warning sound and/or light to prevent the mobile communication apparatus from going out of transmission range with the auxiliary alert device to avoid Bluetooth signal interruption.

2. The auxiliary alert device for mobile communication apparatus as claimed in claim 1, wherein the a microcontroller, is coupled to a sound-effect player, a speaker, and a light-emitting element.

3. The auxiliary alert device for mobile communication apparatus as claimed in claim 2, wherein the microcontroller allows a user to program for ringing sound, so that the auxiliary alert device is able to emit different sounds for indicating purpose.

4. The auxiliary alert device for mobile communication apparatus as claimed in claim 2, wherein the microcontroller allows user setting of a caller identification (ID) display function for the auxiliary alert device, so that the user is able to recognize a caller directly on the auxiliary alert device.

5. The auxiliary alert device for mobile communication apparatus as claimed in claim 1, wherein the control circuit is connected to a USB terminal provided on the housing, so that the auxiliary alert device can be connected to a computer via the USB terminal for charging purpose and setting up different control programs.
